(19) United States
(12) Patent Application Publication
(10) Pub. No.: US 2006/0276729 A1
(43) Pub. Date: Dec. 7, 2006

(54) Method and device for treating obesity by suppressing appetite and hunger using vibration

(76) Inventors: Pamela S. Reed, (US); W. Gilmer Reed, (US)

Correspondence Address: Pamela S. Reed, Suite 509, 211 Blount Ave., Knoxville, TN, 37920, US

(21) Appl. No.: 11/442,015

(22) Filed: May 26, 2006

Related U.S. Application Data
(60) Provisional application No. 60/689,970, filed on Jun. 7, 2005.
(60) Provisional application No. 60/693,807, filed on Jun. 20, 2005.
(60) Provisional application No. 60/720,386, filed on Sep. 21, 2005.

(51) Int. Cl. A61H 1/00

(52) U.S. Cl. 601/46

(57) ABSTRACT

Disclosed is a method and device for treating obesity by suppressing appetite and hunger for periods of time when a person is wearing the vibration motor device. The vibration device having one or more vibrating motor unit(s), a battery holder for each vibrating motor unit, a power source (e.g., a battery) for operating the vibrating motor unit, optional resistor(s) an on/off switch and a necklace to suspend the vibrating device positioned over the stomach on the surface of the skin

### RELATED APPLICATIONS

The benefit of Provisional Application Ser. Nos. 60\689,970 filed Jun. 7, 2005, 60\693,807 filed Jun. 20, 2005 and 60\720,386 filed Sep. 21, 2005, respectively, is hereby claimed. The disclosures of these provisional applications are incorporated herein by reference.

### BACKGROUND OF THE INVENTION

1. Field of the Invention

This invention relates generally to the treatment of obesity and more particularly, is concerned with means and methods for suppressing the appetite and hunger to aid in weight loss of an individual.

2. Description of Related Art

The process for treating obesity is based on psychotherapeutic, pharmacological, surgical and/or dietary provisions currently in use. All have some immediate and/or delayed risk with surgery posing the highest risk.

Also, treatment failures in achieving the intended aim of maintaining weight loss are common.

### SUMMARY OF THE INVENTION

This invention resides in a method and device for treating obesity by suppressing appetite and hunger for periods of time when a person is wearing a removable battery-operated vibration motor device positioned over the stomach on the surface of the skin. The vibration motor device having one or more vibrating motor unit(s), a battery holder for each vibrating motor unit, a power source (e.g., a battery) for operating the vibrating motor unit, optional resistor(s) an on/off switch and a necklace to suspend the vibrating device positioned over the stomach on the surface of the skin

For treating obesity, it would be desirable to provide a means for suppressing one's appetite or hunger without the use of drugs or the need for surgery.

Accordingly, it is an object of the present invention to provide a new device which can be positioned upon a pre-selected region of the user's body and which, when actuated, suppresses appetite and hunger of the user and a method for using the device.

Still another object of the present invention is to provide such a device which is uncomplicated in construction and relatively easy to operate.

Yet another object of the present invention is to provide such a method which obviates the need for drugs or surgery to control obesity and lose weight.

It is an object of the invention to provide a method and device for treating obesity by suppressing appetite and hunger by the delivery of vibration for periods of time when a person is wearing the activated vibration motor device when positioned over the stomach on the surface of the skin.

It is an object of the present invention to provide a vibration motor device suppressing appetite and hunger having one or more vibrating motor unit(s), a battery holder, vibrating motor unit, a power source (e.g., a battery) for operating the vibrating motor unit, optional resistor(s) an on/off switch and a necklace

It is an object of the present invention to provide a painless vibration generated by a vibratory motor device applied over the surface of the skin resonating through the subcutaneous tissues, underlying musculature and underlying tissue soft tissue to reach the stomach wall to suppress appetite and hunger.

It is an object to provide a method and device for vibratory stimulation on the stomach wall indicating the satiety in the fed state without the ingestion of food suppressing hunger.

It is an object to provide a method and device for vibratory stimulation on the stomach wall to limit the amount of food intake when eating suppressing the appetite.

It is further an object of the present invention to supply stimulation through a vibrating motor device supporting appetite and hunger suppression by mimicking vibratory wave forms on the stomach wall.

It is an object of the present invention to suppress appetite and hunger by artificially supplying a vibratory stimulation over the stomach wall by vibrations from a battery operated brush or brushless vibration motor.

It is an object of the invention to provide a vibrating motor unit positioned in the empty cell of the battery holder.

It is an object of the present invention to provide a vibratory motor device that is freely moveable over the stomach.

It is an object of the present invention to provide a vibrating motor device of the disposable type.

It is an object of the present invention to provide a vibratory motor device both for continuous stimulation and for “on demand” stimulation by way of an on/off switch located on the vibrating motor device for appetite and hunger suppression.

It is an object of the present invention to provide a method and device for a person desiring to reduce body weight using the vibrating motor device when eating to reduce caloric intake or when fasting to prevent hunger.

It is an object of the invention to provide a vibrating motor device for appetite and hunger suppression that may be worn when practical and activated in times when a person is wearing which appetite and hunger suppression is desired.

It is an object of the invention to provide a vibrating motor device to suppress appetite and hunger that can be used both for continuous stimulation and for “on demand” stimulation, i.e. by an on/off slide switch

It is an object of the present invention to provide a removal battery operated vibrating motor device to suppress appetite and hunger.

It is another object of the present invention to provide a battery holder with removable top cover to allow replacement of battery.

It is yet another object of the present invention to provide a battery holder with power source and vibrating motor unit disposed within the bottom housing.

It is a further object of the invention to provide an adjustable necklace with a convenience release and a length adjuster slide for positioning the vibrating motor device over the stomach wall on the surface of the skin; whenever appetite and hunger suppression are warranted.

It is an object of the present invention to provide a portable, battery-powered, vibrating motor device for the treatment of obesity that is a wearable apparatus a user may conceal under ones clothes.

It is another object of the inventor to provide a method and device for the prevention or treatment of constipation by stimulating the stomach wall.

It is yet another object of the present invention to provide a method of suppressing appetite or hunger using a vibration motor device that makes contact with skin positioned over the stomach wall.

It is still another object of the present invention to provide a method and device to decrease body weight in individuals by suppressing appetite and hunger.

It is yet another object of the invention to provide a method of suppressing appetite or hunger using a vibrating motor device in which the depth of vibration penetration is to the stomach wall.

It is another object of the invention to provide a method of suppressing appetite or hunger with an adjustable means of vibration intensity through resistors.

It yet another feature that the device, that the device can be removed when appetite or hunger suppression is not warranted.

An object of the present invention is a device for appetite and hunger suppression that may be removed any time, such as when bathing or exercising, or during other activities that may make wearing the device is impractical.

Still another object is to provide a method of achieving a non-invasive means of controlling appetite by stimulating the stomach muscle wall using a non-invasive vibrating motor placed on the surface of the skin overlying the stomach wall.

Another object is to provide a method and device for appetite and hunger suppression that is not particularly difficult to use, since the simple operative includes placing a necklace with the device positioned at one end over the stomach and the other end around a person's neck.

Another object is to provide a method and device to reduce heart rate when wearing the vibrating motor device which is an unexpected finding of yet unknown etiology.

These and other objects of the present invention will become readily apparent upon further review of the following specification and drawings.

The method and device thus conceived is susceptible to numerous modifications and variations, all of which are within the scope of the present inventive concept.

Furthermore, all the details may be replaced with technically equivalent elements. The materials employed, the shapes and the dimensions may be any according to the requirements

Finally another object of the present invention is to provide a device implementing the method.

### BRIEF DESCRIPTION OF THE DRAWINGS

The above and other objects, features, and advantages will become readily apparent from the following description, reference being made to the accompanying drawing in which:

FIG. 1 is a sectional view of the stomach;

FIG. 2 is a frontal view showing a person wearing the battery operated device over the stomach by way of suspension using an adjustable necklace;

FIG. 3 is a perspective view showing the embodiment of a battery operated vibration motor device with top cover removed.

### GENERAL DESCRIPTION OF THE INVENTION

In order to further clarify the method and device for treating obesity the motor physiology of the stomach and current market available DC vibratory motors are described.

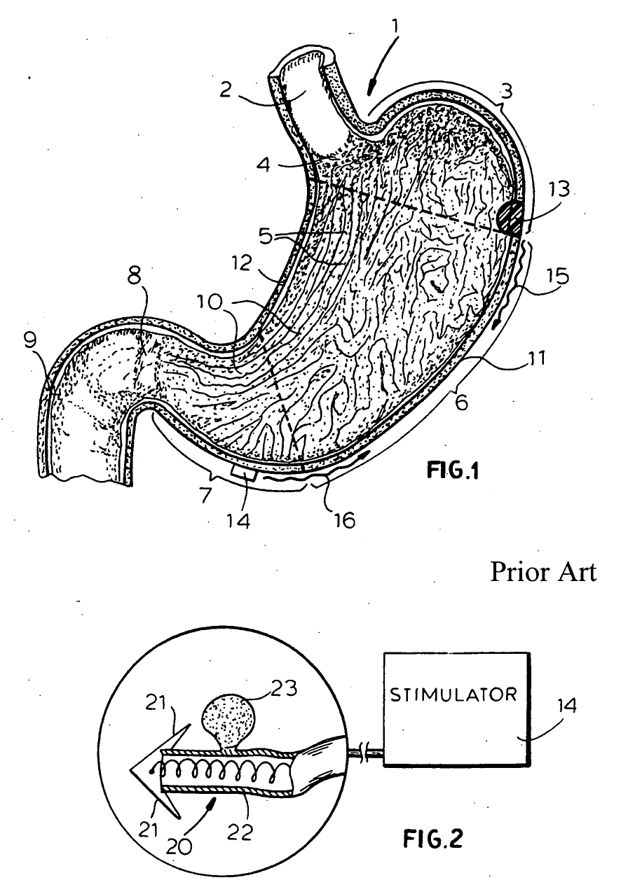

The stomach 1 in FIG. 1 is supplied by the esophagus 2, and has the fundus ventriculi 3, the cardia 4, a gastric canal 5, the corpus ventriculi 6, the antrum of the stomach 7, the pylorus 8, the duodenum 9 and the mucous folds 10.

As is known, the stomach is divided into two parts as regards to its motility: the fundus ventriculi 3, which has tonic wall movements, and the central part or corpus 6, which is characterized by phasic activity. Propulsive gastric movements begin at a point proximate to the greater curvature which is not clearly identified anatomically and is termed “gastric pacemaker”.

The “gastric pacemaker” 13 sends electrical waves (depolarization potential) approximately three times per minute; these electrical and produced vibratory waves spread in an anterograde direction along the entire stomach.

The antrum 7 of the stomach has a continuous phasic activity which has the purpose of mixing the food that is present in the stomach. The passage of food into the duodenum 9 is therefore the result of a motility which is coordinated among the antrum 7, the pylorus 8 and the duodenum 9. To describe with greater clarity, when the food has passed through the esophagus 2, it reaches the stomach.

The “gastric pacemaker” 13 spontaneously and naturally generates electrical and vibratory waves 15 along the entire stomach; these waves allow the antrum 7, with movements which are coordinated together with those of the pylorus 8 and the duodenum 9, to make the food pass into the subsequent portions of the alimentary canal.

The gastrointestinal tract is responsible for an essential step in the digestive method, the reception of nutrition in the human body. An important element of the digestive method is peristalsis, the coordinated and self-regulated motor activity of the intestinal tract. Peristalsis is accomplished through a coordinated combination of electrical, chemical, neurological, vibratory and hormonal mediation, as well as possibly other, as yet unknown, mechanisms

Motility is one of the most critical physiological functions of the human gut. Without coordinated motility, digestion and absorption of dietary nutrients could not take place. To accomplish its functions effectively, the gut needs to generate not just simple contractions but contractions that are coordinated to produce transit of luminal contents (peristalsis). Thus, coordinated gastric contractions are necessary for the emptying of the stomach. The patterns of gastric motility are different in the fed state and the fasting state (Yamada et al. 1995). In the fed state, the stomach contracts at its maximum frequency, 3 cycles/min (cpm) in humans and 5 cpm in dogs. The contraction originates in the proximal stomach and propagates distally toward the pylorus. In healthy humans, the ingested food is usually emptied by 50% or more at two hours after the meal and by 95% or more at four hours after the meal (Tougas et al. 2000). The pattern of gastric motility changes when the stomach is emptied. The gastric motility pattern in the fasting state undergoes a cycle of periodic fluctuation divided into three phases: phase I (no contractions, 40-60 minutes), phase II (intermittent contractions, 20-40 minutes) and phase III (regular rhythmic contractions, 2-10 minutes).

Gastric emptying plays an important role in regulating food intake. Several studies have shown that gastric distention acts as a satiety signal on the “gastric pacemaker” to inhibit food intake (Phillips and Powley 1996) and rapid gastric emptying is closely related to appetite suppression and obesity (Duggan and Booth 1986). Gastric emptying contributes to the ability to inhibit food intake. The regular rhythmic peristaltic contractions, present in the fed state, stimulate the stomach wall with waves of contractions at a frequency of 3 cycles/minute. The stimulation of the stomach wall with distention of the stomach wall by food, are felt to regulate food intake. Stimulating the stomach wall is the method of the present invention. By stimulating the stomach wall, hunger and appetite suppression may be achieved. The added benefit of the prevention or treatment of constipation by stimulating the stomach wall is also achieved.

Now that the known physiology of the gastric motility of a mammal, such as a human being, has been established, the method according to the invention consists in artificially altering, by means of vibrations simulating distention of the stomach wall, for periods of time when a person is awake wearing the device, to suppress hunger and appetite by applying vibrations over the stomach wall and more specifically to the “gastric pacemaker”.

This invention provides a portable, battery-powered, commercially available vibrating motor that is a wearable apparatus a user may conceal under ones clothes. More particularly, a vibration is generated by a brush or brushless vibrating motor although other vibrating motors may generate the desired amount of vibration. In this manner, the vibration stimulus generates, along the stomach wall, vibration which corresponds when distention by food intake occurs in the stomach.

The painless vibration generated by a vibratory motor, applied to the surface of the skin, resonate through the subcutaneous tissues, underlying musculature and underlying tissue to reach the stomach wall. In this manner, the vibration stimulates the stomach wall as would distention of the stomach wall in the fed state.

Succinctly, the vibratory stimulation of the stomach wall indicates the satiety of food in the fed state without the ingestion of food into the stomach. The vibratory stimulation may also limit the amount of food intake during the fed state. Therefore, the vibratory stimulation supports appetite suppression and hunger by mimicking vibratory wave forms on the stomach wall.

In other words, the application of vibration on the stomach wall suppresses appetite when food is in the stomach by mimicking distention of the stomach reducing the amount of food intake. The application to controlling hunger, in that no food is in the stomach, is achieved by the vibration stimulating the stomach wall that mimic distention with stimulation of the stomach wall when eating.

The artificial means of supplying a vibrating stimulation device over the wall of stomach can be supplied by vibrations of a DC-operated brush and brushless vibration motors, currently on the market, which have been applied to devices such as a wireless mobile telephone. The motor has a rotor having eccentric mass distribution that causes vibration. The vibrating motors are available in various sizes and shapes. The most commonly used are the flat type vibration motor and a cylinder type vibration motor. The flat type vibration motor has a relatively simple vibration structure, e.g., for rotating a weight which is placed inside the motor. The flat type vibration motor is fabricated thin so that components of a wireless mobile phone can be miniaturized.

A typical prior known DC vibrator motor has an eccentric weight made of a tungsten alloy fixedly mounted on an output shaft of the motor. The shaft rotates due to the unbalanced distribution of mass about the rotational axis causing a vibration.

### DETAILED DESCRIPTION OF THE PREFERRED EMBODIMENTS

These and other features and advantages of this invention will be evident from the following detailed description of preferred embodiments when read in conjunction with the accompanying drawings in which:

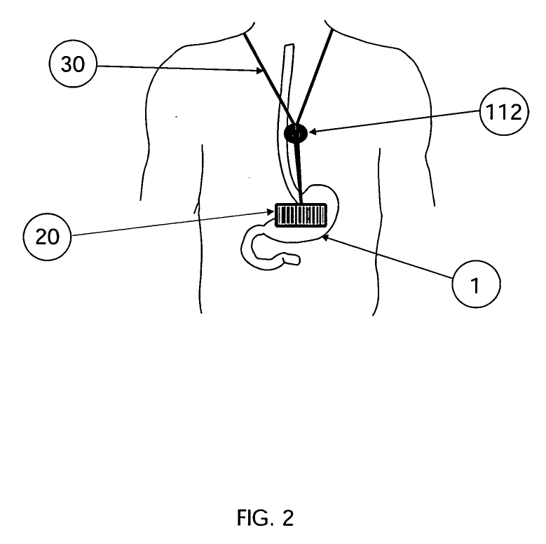

With reference to FIG. 2 there is shown a frontal view of a person wearing the battery operated vibrating motor device 20 over the stomach by way of suspension, using an adjustable necklace. The vibrating motor device 20 measures 63 mm in length, 25.60 mm in width and 15.5 mm in height. The entire vibrating motor device 20 may be constructed in many different colors, size and shape. The adjustable necklace 30 length in FIG. 2 may vary in length from person to person based on body stature and is measured by placement around the neck of the user and suspending the vibrating motor device 20 over the stomach 1. The nylon adjustable necklace 30 includes a length adjuster slide 112 for positioning the vibrating motor device over the stomach wall allowing free movement of the device 20. The vibration that a wearer may experience is mild tingling in the area under placement for the device 20.

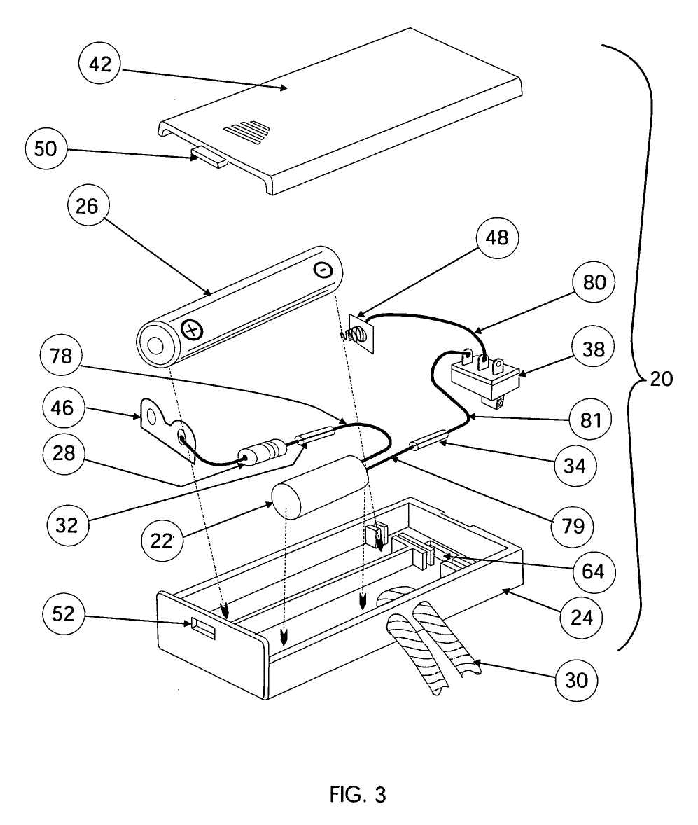

FIG. 3 is a perspective view showing the embodiment of a battery operated vibrating motor device with top cover 42 removed and parts suspended disposing the vibrating motor unit and power source in the bottom housing 24.

FIG. 3 illustrates a circuit with one pole of a slide switch 38 connected to a spring plate 48 by way of a wire 80. A DC battery 26 is positioned in the bottom housing 24 between the negative spring plate 48 and double side positive plate 46. The double side positive plate 46 connects to the resistor 28 by way of a wire lead from the resistor. The resistor 28 connects to the positive lead wire 78 from the vibrating motor unit 22 by way of a butt connector 32. The negative vibrating motor lead wire 79 is connected to a second pole of the slide switch 38 by way of a second butt connector 34 and wire 81 completing the circuit with the slide switch activated.

The slide switch 38 is a sub-mini slide switch rated at 0.3A at 125 VAC. FIG. 3 shows positioning of the slide switch 38 in a cut out 64 of the bottom housing 24.

The 22-26 gauge butt connectors 32 and 34 are crimped tightly connecting the wires. The resistor 28 is a 33-Ohm ½ watt with 5% tolerance is shortened at both ends to 10 mm in length connecting the double side positive plate 46 and positive lead wire 78 of the vibrating motor device 22.

The use of a resistor 28 reduces the voltage to the vibrating motor unit 22 from a 1.5 volt battery power source 26 below 0.985 volts when using a 33-Ohm resistor 28 with ½ watt and 5% tolerence. Reducing the voltage from the power source 26 to the vibrating motor unit 22 decreases the intensity of vibration through the bottom housing 24 to the stomach wall 1 and “gastric pacemaker” 13 making the vibrating motor device 20 tolerable. The reduction in voltage with resistor 28 to the vibrating motor unit 22 allows for tolerance when wearing the device 20 and decreasing side effects.

Those side effects include nausea, headaches and diarrhea which increase in severity and frequency as the voltage to the vibrating motor unit 22 increases. A 1.5 volt battery 26 without a resistor 28 could be intolerable for some individuals, when placed over the stomach 1, due to the described side effects. There is a level of comfort below 1.5 volts having little to no side effects while still being effective at suppressing appetite and hunger. The resistor 28 thus provides a means of adjusting the vibration intensity.

The vibrating motor unit 22 may be manufactured in several different lengths and vibration ranges. The preferred embodiment is a vibrating motor unit 22 in FIG. 3 with color coded wire leads 78-79 which is a coreless cylindrical permanent micro vibration brush motor DC model supplied by VibratorMotor®. The vibrating motor unit 22 has a preset vibration from the off center head (eccentric) mounted on a motor. The preferred embodiment is a motor diameter of 7.8 mm in width and 21.9 mm in length. The operating conditions are a rated voltage of 1.3 V DC, rated speed of 7,500+ or −1,500 rpm, clockwise rotation, and voltage of 1.1-1.6 v DC. The mechanical specifications are a shaft end play of 0.1-0.03 mm, 2.86 gram weight of motor and holding strength of vibration weight of 40N (5 kgf). The performance and characteristics are a rated current of 75 mA max, stall current of 130 mA max, starting voltage of 0.7V DC max at rated load and insulation resistance of 1M-Ohm min at a DC 100V between the wires and motor body. The contact resistance is 11-Ohms. The mechanical noise is 50 db (A) maximum. The vibration frequency is 10 to 55 Hz. The life of the motor is 200,000 to 400,000 cycles.

The DC battery 26 may be replaced when the voltage drops below the operating voltage of the vibrating motor unit 22 approximately 60 hours after beginning operation. The DC battery 26 is replaced by removing the top cover 42 which is held in place by a tab extension 50 inserted into an opening 52 into the bottom housing 24.

The adjustable necklace 30 in FIG. 2 & FIG. 3 may vary in length from person to person based on body stature and is measured by placement around the neck of the user suspending the vibrating motor device 20 over the stomach wall 1 in the region of the “gastric pacemaker” 13 shown in FIG. 1 & FIG. 2. The nylon adjustable necklace 30 includes a length adjuster slide 112 to position the vibrating motor device 20 over the stomach wall 1 allowing free movement. The vibration that a wearer may experience with the slide switch 38 in the on position is mild tingling beneath the area of placement of the vibrating motor device 20.

The disposable vibrating motor device 20, with the vibrating motor unit 22 has a life of operation between 240 and 300 hours with the slide switch 38 activated. The vibrating motor device 20 is small enough to be worn under a shirt or blouse and is positioned on the surface of the skin by the wearer overlying the stomach.

Therefore, the vibratory motor device 20, according to the motor vibration phenomenon provides, for the period of time the device is worn, a method of suppressing appetite and hunger when the vibrating motor device 20 is activated when positioned over the stomach.

The disposable vibrating motor device 20 can be used both for continuous stimulation and for “on demand” stimulation, i.e. by an on/off slide switch 38

In this case, the person desiring to reduce body weight may use the vibration motor when eating to reduce caloric intake or when fasting to prevent hunger. Thirst is not affected by the vibration motor unit.

Modifications such as a rechargeable battery system, using a single or multiple cell battery holder, different resistors, the use of a lower voltage battery, which would not require the use of a resistor, different motor units, resistor connections to either positive or negative wiring, different styles of necklace or changes in size, shape or battery holder design of the device may be considered.

Other modifications such as changing the power source 26 from DC to AC current may be used with changes in the holder for vibrating motor acceptance is also considered.

We claim:

1. A method and Device for treating Obesity by suppressing Appetite and Hunger using Vibration comprising:
a power source;
a vibrating motor unit;
a resistor;
a battery holder having a connecting top cover and bottom housing configuration to contain said power source and said vibrating motor unit:
wherein said power source and said vibrating motor unit are disposed within said battery holder;
and wherein said vibration stimulates the stomach wall to provide a method to suppress Appetite and Hunger when activating said vibrating motor device.

2. The vibrating motor device to suppress Appetite and Hunger according to claim 1, wherein said power source is a battery.

3. The vibrating motor device to suppress Appetite and Hunger according to claim 1, wherein said top cover and bottom housing is a battery holder allowing for battery replacement.

4. The vibrating motor device to suppress Appetite and Hunger according to claim 1, wherein said resistor reduces the intensity of vibration over the stomach wall.

5. A vibrating motor device for treating constipation comprising:
a power source;
a vibrating motor unit;
a resistor;
a battery holder having a connecting top cover and bottom housing configuration to contain said power source and said vibrating motor unit;
wherein said power source and said vibrating motor unit are disposed within said battery holder;
and wherein said vibration stimulates the stomach wall to provide a method to relieve constipation when activating said vibrating motor device.

6. A vibrating motor device for treating tachycardia comprising:
a power source;
a vibrating motor unit;
a resistor;
a battery holder having a connecting top cover and bottom housing configuration to contain said power source and said vibrating motor unit;
wherein said power source and said vibrating motor unit are disposed within said battery holder;
and wherein said vibration stimulates the stomach wall to provide a method to treat tachycardia when activating said vibrating motor unit.
